(19) United States
(12) Patent Application Publication
(10) Pub. No.: US 2014/0037872 A1
(43) Pub. Date: Feb. 6, 2014

(54) FOOT CUSHION

(71) Applicant: TSUNG-CHIEH HUANG, Kaohsiung (TW)

(72) Inventor: TSUNG-CHIEH HUANG, Kaohsiung (TW)

(21) Appl. No.: 13/565,821

(22) Filed: Aug. 3, 2012

(51) Int. Cl. A47B 91/00; B32B 1/04

(52) U.S. Cl. 428/34.1

(57) ABSTRACT

A foot cushion for desk or chair consists of welded upper seat and lower pad by the means of secondary processing molding. A receiving portion is formed to an upper portion of the upper seat for receiving a foot of the desk or chair. The lower pad is welded to the bottom of the upper seat. The upper seat has stronger hardness than the lower pad, and the lower pad has higher resilience than the upper seat. The upper seat will tightly connected to the foot of the desk or chair, and the lower pad attached to the upper seat will never come off and provide soft contact to the ground without scratching, slippage, and noise.

### FIELD OF THE INVENTION

The present invention relates to foot cushions, and particular to a foot cushion applied to foot of a desk or chair.

### DESCRIPTION OF THE PRIOR ART

Prior foot cushions for isolating the feet of a desk and the floor are made of single material such as plastic, rubber, or wool. Such material has to be hard to be tightly attached to the feet so that it can still cause a scratch or noise during movement. However, a softer foot cushion without above issues is fragile and easily coming off from the feet. The attachable wool pads attached to the bottoms of the feet is also fragile and easily cause more dirt.

To solve above disadvantages, the design and the structure of the cushion must not be constrained. To improve the life time and performance of the foot cushion is a urgent goal to achieve.

### SUMMARY OF THE PRESENT INVENTION

Accordingly, the primary object of the present invention is to provide a foot cushion of the following functions.

1. The foot cushion can be tightly attached to the foot of a desk or chair. The foot cushion can prevent scratch, slippage, and noise.

2. To prevent disadvantages of extremely hard cushion of scratching, slippage, and noisy.

3. To prevent disadvantages of extremely soft cushion of dropping, and deformation.

4. To prevent disadvantages of attachable wool cushion of coming off, and fragile.

To achieve above objects, the foot cushion for desk or chair consists of welded upper seat and lower pad by the means of secondary processing molding. A receiving portion is formed to an upper portion of the upper seat for receiving foot of the desk or chair. The lower pad is welded to the bottom of the upper seat. The upper seat has stronger hardness than the lower pad, and the lower pad has higher resilience than the upper seat.

The upper seat will tightly connected to the foot of the desk or chair, and the lower pad attached to the upper seat will never come off and provide soft contact to the ground without scratching, slippage, and noise.

### BRIEF DESCRIPTION OF THE DRAWINGS

FIG. 1 is a schematic view showing a first embodiment of the present invention.

FIG. 2 is a perspective view showing the first embodiment of the present invention.

FIG. 3 is another perspective view showing the first embodiment of the present invention.

FIG. 4 is a cross-section view through a 4-4 line in the FIG. 3.

FIG. 5 is a cross-section view through a 5-5 line in the FIG. 2.

FIG. 6 is a perspective view showing a non-flat joint surface of the second embodiment of the present invention.

FIG. 7 is another perspective view showing the non-flat joint surface of the second embodiment of the present invention.

FIG. 8 is a cross-section view through an 8-8 line in the FIG. 7.

FIG. 9 is a cross-section view through a 9-9 line in the FIG. 6.

FIG. 10 is a perspective view showing a block of the third embodiment of the present invention.

FIG. 11 is another perspective view showing the block of the third embodiment of the present invention.

FIG. 12 is a cross-section view through a 12-12 line in the FIG. 11.

FIG. 13 is a cross-section view through a 13-13 line in the FIG. 10.

FIG. 14 is a perspective view showing a block of the fourth embodiment of the present invention.

FIG. 15 is another perspective view showing a block of the fourth embodiment of the present invention.

FIG. 16 is a cross-section view through a 16-16 line in the FIG. 15.

FIG. 17 is a cross-section view through a 17-17 line in the FIG. 14.

FIG. 18 is a schematic view showing a fifth embodiment of the present invention.

FIG. 19 is a perspective view showing the fifth embodiment of the present invention.

FIG. 20 is another perspective view showing the fifth embodiment of the present invention.

FIG. 21 is a cross-section view through a 21-21 line in the FIG. 20.

FIG. 22 is a cross-section view through a 22-22 line in the FIG. 21.

FIG. 23 is a perspective view showing a non-flat joint surface of the fifth embodiment of the present invention.

FIG. 24 is another perspective view showing a non-flat joint surface of the fifth embodiment of the present invention.

FIG. 25 is a cross-section view through a 25-25 line in the FIG. 24.

FIG. 22 is a cross-section view through a 26-26 line in the FIG. 24.

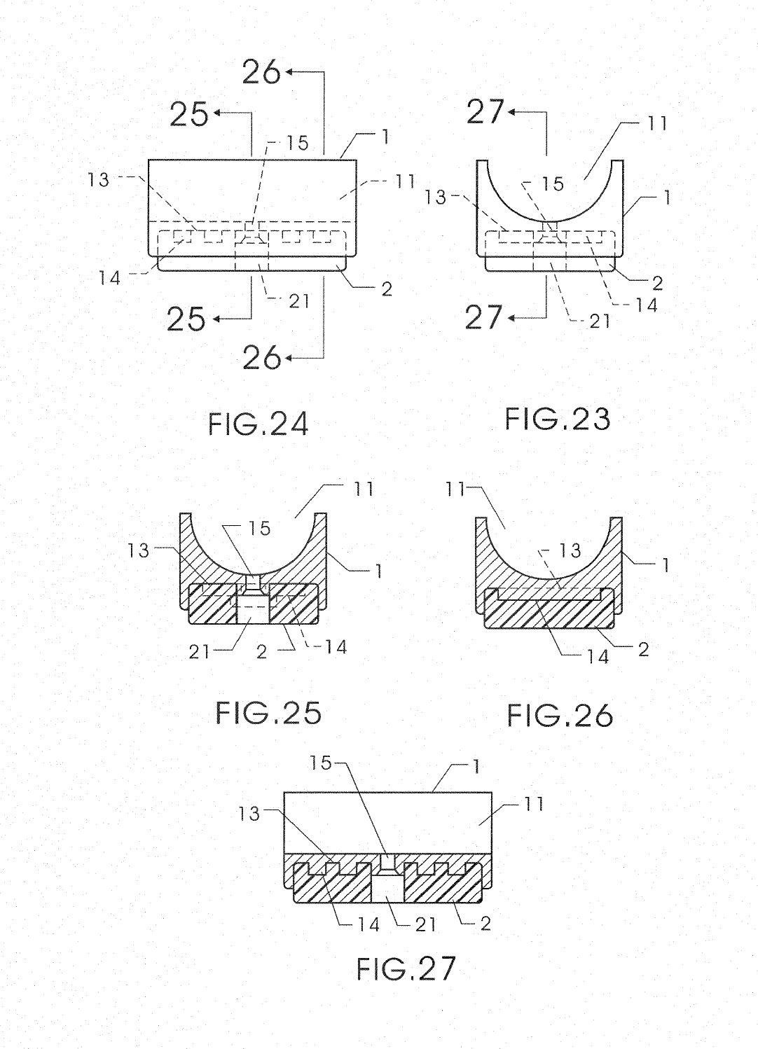

FIG. 27 is a cross-section view through a 27-27 line in the FIG. 23.

FIG. 28 is a perspective view showing a sixth embodiment of the present invention.

FIG. 29 is another perspective view showing the sixth embodiment of the present invention.

FIG. 30 is a cross-section view through a 30-30 line in the FIG. 29.

FIG. 31 is a cross-section view through a 31-31 line in the FIG. 28.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

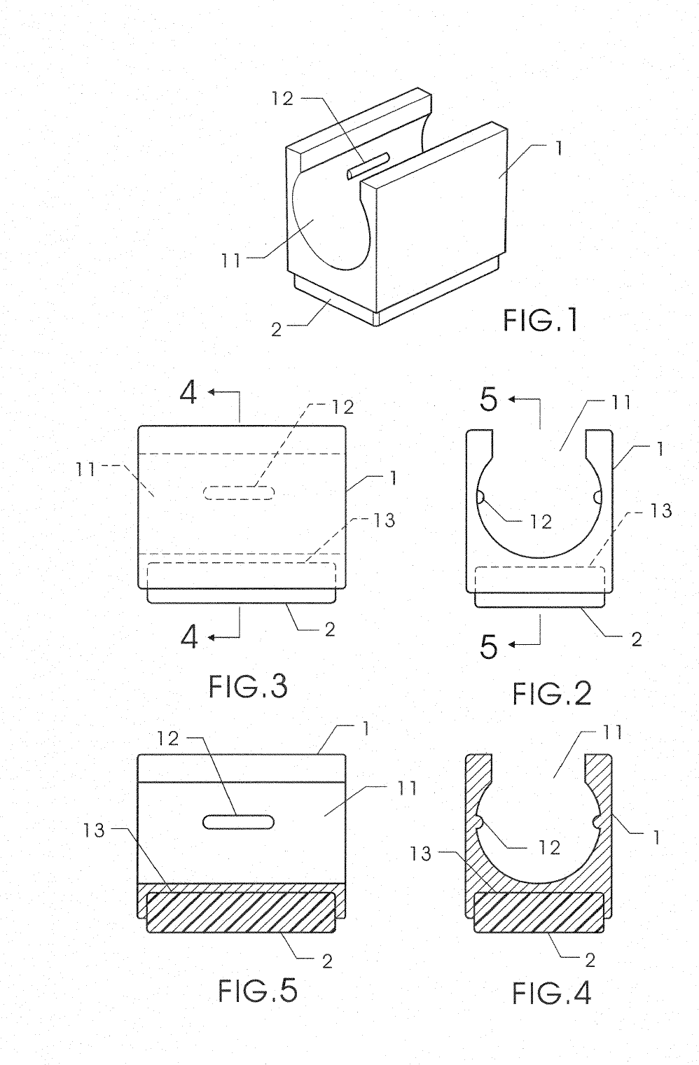

Referring to FIGS. 1 to 5, the foot cushion consists of welded upper seat 1 and lower pad 2 by the means of secondary processing molding. The upper seat 1 is made of moldable material. The upper seat 1 has stronger hardness than the lower pad 2, and the lower pad 2 has higher resilience than the upper seat 1. A receiving portion 11 is formed to an upper portion of the upper seat 1. The upper seat 1 has two protruding retaining portion 12 on two opposite inner walls. The two retaining portions 12 serves to retain two recesses formed to the desk foot while the desk foot is received by the receiving portion 11 of the upper seat 1 so that the desk foot can be tightly secured within the upper seat 1.

Referring to FIGS. 1 to 5, a joint surface 13 is formed to a lower portion of the upper seat 1. The joint surface 13 is flat, and the lower pad 2 is welded to the joint surface 13 by molding. The lower pad 2 has higher resilience than the upper seat 1, while the upper seat 1 has stronger hardness than the lower pad 2. The lower pad 2 is made of moldable material of above criteria.

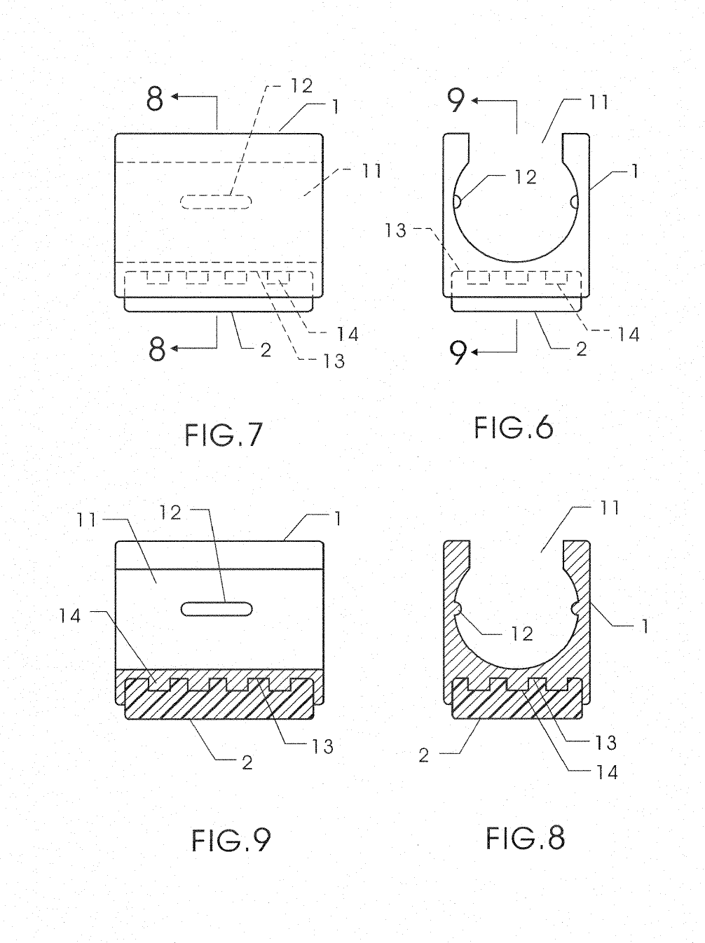

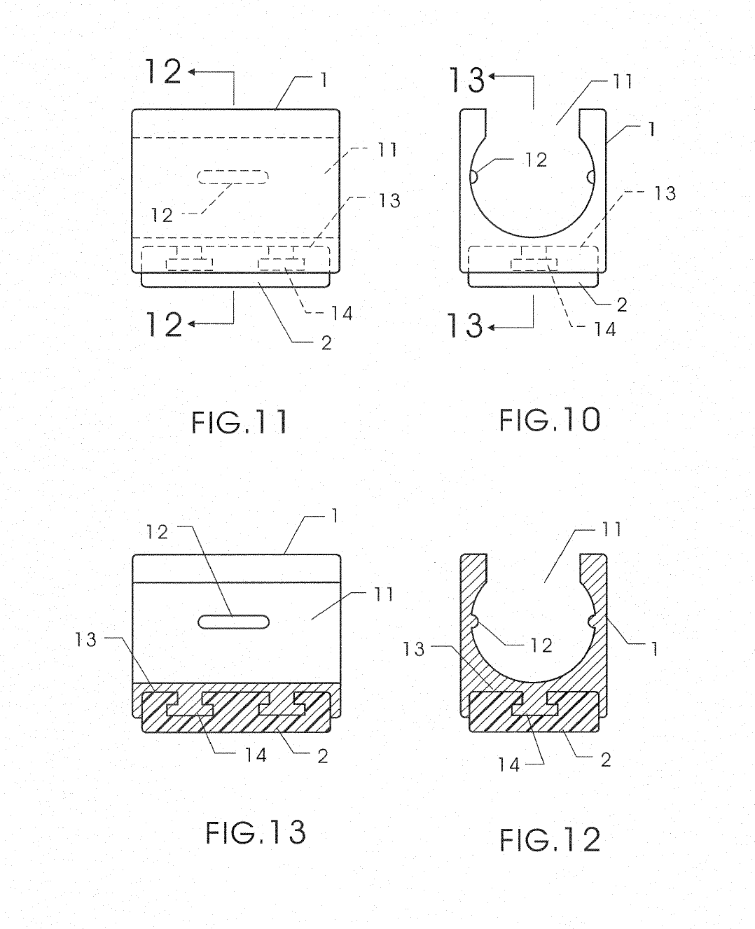

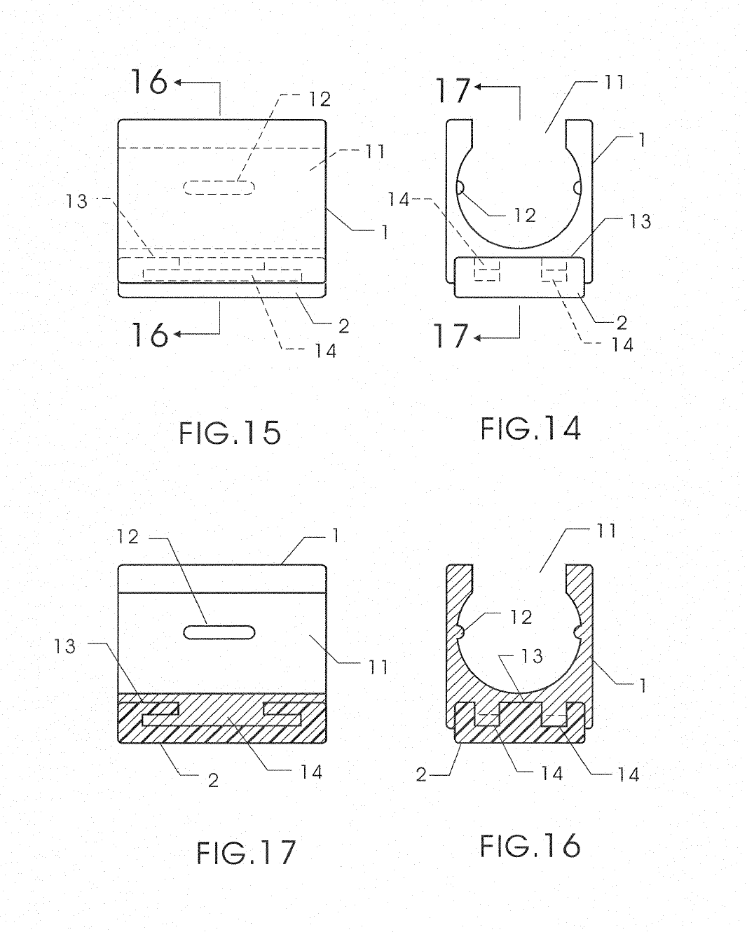

Referring to FIGS. 6 to 16, the joint surface 13 has at least one block 14 so that the lower pad 2 can be tightly welded to the upper seat 1 by molding.

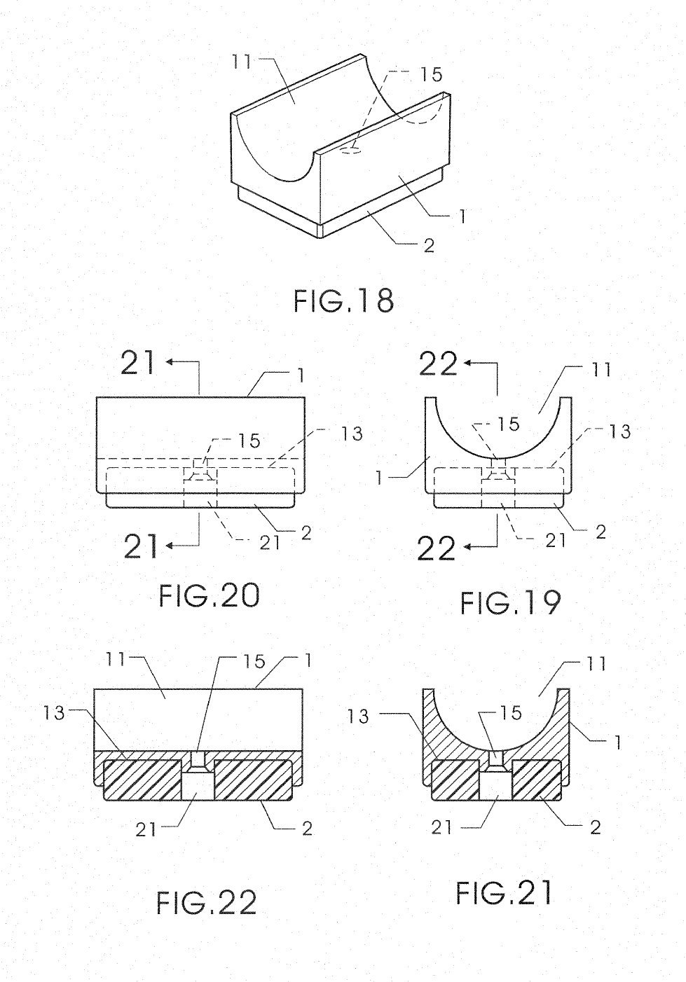

Referring to FIG. 18, another embodiment according to the present invention is illustrated. The foot cushion consists of welded upper seat 1 and lower pad 2 by the means of secondary processing molding. The upper set 1 is made of moldable material. The upper seat 1 has stronger hardness than the lower pad 2, and the lower pad 2 has higher resilience than the upper seat 1. A receiving portion 11 is formed to an upper portion of the upper seat 1. The receiving portion has a through hole 15 for a fixing component (such as a bolt) so that the upper seat 1 can be fixed to the desk foot by the fixing component.

Referring to FIGS. 19 to 22, a through hole 21 for the fixing component (such as a bolt) is formed to the lower pad 2 corresponding to the through hole 15 of the upper seat 1. The lower pad 2 has higher resilience than the upper seat 1, while the upper seat 1 has stronger hardness than the lower pad 2. The lower pad 2 is made of moldable material of above criteria.

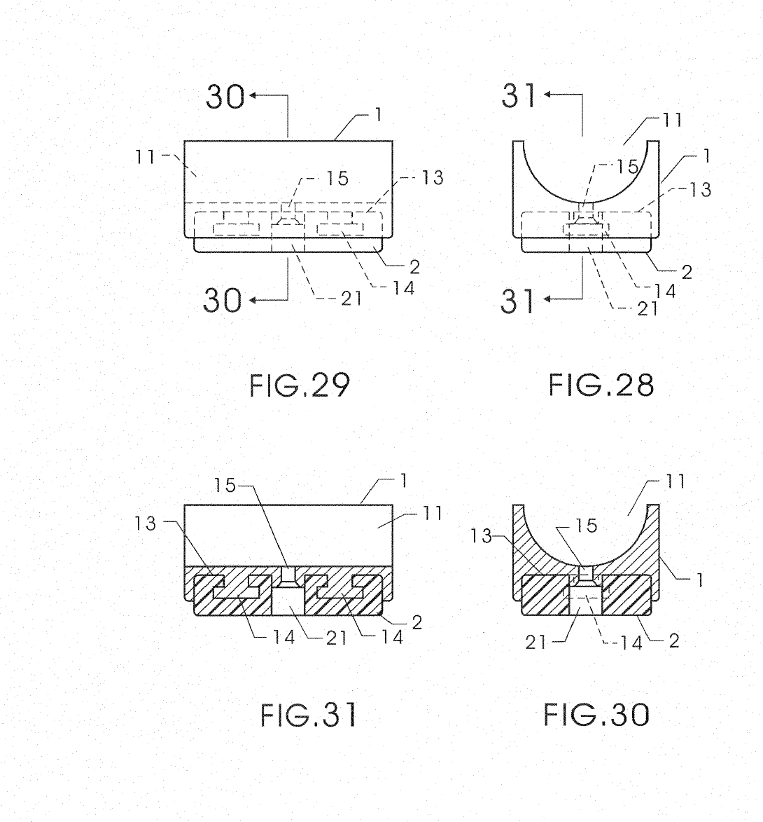

Referring to FIGS. 23 to 31, the joint surface 13 has at least one block 14 so that the lower pad 2 can be tightly welded to the upper seat 1 by molding.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1-6. (canceled)

7. A foot cushion comprising:
an upper seat (1) made of moldable material; an upper portion of the upper seat having a receiving portion (11); the upper seat having two protruding retaining portions (12) on two opposite inner walls of the receiving portion (11); the two retaining portions (12) serving for retaining two recesses formed to a desk foot while the desk foot is received by the receiving portion (11) of the upper seat (1) so that the desk foot can be tightly secured within the upper seat (1); and
a lower pad (2) welded to the upper seat; the upper seat having stronger hardness than a hardness of the lower pad; and the lower pad having higher resilience than the upper seat.

8. The foot cushion as claimed in claim 7, wherein a joint surface (13) is formed to a lower portion of the upper seat (1); the joint surface (13) is flat, and the lower pad (2) is welded to the joint surface (13).

9. The foot cushion as claimed in claim 7, wherein the joint surface (13) has at least one block (14) so that the lower pad (2) can be tightly welded to the upper seat (1).

10. The foot cushion as claimed in claim 7, wherein the receiving portion (11) of the upper seat (1) has a through hole (15) for receiving a fixing component so that the upper seat (1) can be fixed to the desk foot by the fixing component.

11. The foot cushion as claimed in claim 10, wherein the lower pad has a through hole (21) for receiving the fixing component; in assembly state; the through hole (21) of the lower pad is communicated to the through hole (15) of the upper seat (1).

12. The foot cushion as claimed in claim 7, wherein a joint surface (13) is formed to a lower portion of the upper seat (1); and the joint surface (13) has at least one block (14) so that the lower pad (2) can be tightly engaged to the upper seat (1).
